(19) United States
(12) Patent Application Publication
(10) Pub. No.: US 2026/0025034 A1
(43) Pub. Date: Jan. 22, 2026

(54) ELECTRIC MOTOR ROTOR SEGMENT RADIAL INTERLOCKING RETENTION

(71) Applicant: Schaeffler Technologies AG & Co. KG, Herzogenaurach (DE)

(72) Inventors: Eric Ubelhart, Orrville, OH (US); Jacob Sheradin, North Canton, OH (US)

(21) Appl. No.: 18/779,743

(22) Filed: Jul. 22, 2024

(51) Int. Cl. H02K 1/28

(52) U.S. Cl. CPC H02K 1/28

(57) ABSTRACT

A rotor may be segmented into annular segments to assist in manufacturing and provide material savings. Switching from a full circle rotor lamination to a segmented lamination may reduce a structural strength of the rotor to resist centrifugal forces and expansion during high speed or high temperature operation. The annular segments may include radial joints to provide sufficient strength to resist against the centrifugal forces.

### TECHNICAL FIELD

The present disclosure generally relates to electric motors, and more particularly, to rotor structures of the electric motors.

### BACKGROUND

Electric motor rotors may be made of many lamination rings. The lamination rings may be annular. A center of the lamination rings may be waste material during fabrication. Therefore, it would be advantageous to provide a device, system, and method that cures the shortcomings described above.

### SUMMARY

An annular lamination stack is described, in accordance with one or more embodiments of the present disclosure. The annular lamination stack may include: a plurality of lamination stack segments, wherein the plurality of lamination stack segments are segments of an annular shape, wherein the plurality of lamination stack segments abut with circumferentially adjacent of the plurality of lamination stack segments, wherein the plurality of lamination stack segments include: a plurality of annular segments, wherein the plurality of annular segments are laminated together to form the plurality of lamination stack segments, wherein the plurality of annular segments include: an inner diameter; an outer diameter, wherein the inner diameter and the outer diameter define the annular shape; a pair of end faces, wherein the pair of end faces are disposed at opposing circumferential ends of the plurality of annular segments; a plurality of receiving openings; and a plurality of radial joints, wherein the plurality of radial joints extend radially from the inner diameter.

In some aspects, the plurality of receiving openings and the plurality of radial joints are arranged in a polar array about a center axis of the annular lamination stack, wherein the inner diameter and the outer diameter are concentric to the center axis.

In some aspects, a profile of the plurality of lamination stack segments does not change along an axial length of the plurality of lamination stack segments.

In some aspects, the plurality of receiving openings are defined axially through the plurality of annular segments, wherein the plurality of receiving openings are arranged in pairs to form a plurality of V-shapes.

In some aspects, each of the plurality of annular segments includes at least one pair of the plurality of receiving openings.

In some aspects, the pair of end faces do not segment between the pairs of the plurality of receiving openings.

In some aspects, the plurality of radial joints are circumferentially aligned with the pairs of the plurality of receiving openings.

In some aspects, the plurality of annular segments include a plurality of axial grooves, wherein the plurality of axial grooves are defined on the outer diameter through an axial length of the plurality of annular segments.

In some aspects, the plurality of radial joints extend radially inwards from the inner diameter.

In some aspects, the plurality of radial joints include one of a dovetail joint, a jigsaw joint, or a T-joint.

In some aspects, the plurality of annular segments include a ferromagnetic metal or an alloy thereof.

In some aspects, the plurality of annular segments are fabricated from a sheet metal blank via a stamping process.

A rotor core is described, in accordance with one or more embodiments of the present disclosure. The rotor core may include: a plurality of annular lamination stacks, wherein the plurality of annular lamination stacks are radially aligned and axially offset from adjacent of the plurality of annular lamination stacks to define an axial length of the rotor core, the plurality of annular lamination stacks including: a plurality of lamination stack segments, wherein the plurality of lamination stack segments are segments of an annular shape, wherein the plurality of lamination stack segments abut with circumferentially adjacent of the plurality of lamination stack segments, wherein the plurality of lamination stack segments include: a plurality of annular segments, wherein the plurality of annular segments are laminated together to form the plurality of lamination stack segments, wherein the plurality of annular segments include: an inner diameter; an outer diameter, wherein the inner diameter and the outer diameter define the annular shape; a pair of end faces, wherein the pair of end faces are disposed at opposing circumferential ends of the plurality of annular segments; a plurality of receiving openings; and a plurality of radial joints, wherein the plurality of radial joints extend radially from the inner diameter.

In some aspects, the plurality of annular lamination stacks abut with adjacent of the plurality of annular lamination stacks.

In some aspects, the plurality of receiving openings and the plurality of radial joints are radially aligned along the axial length of the rotor core.

In some aspects, the plurality of annular lamination stacks are circumferentially skewed along the axial length of the rotor core, wherein the plurality of radial joints are circumferentially aligned along the axial length of the rotor core.

A rotor assembly is described, in accordance with one or more embodiments of the present disclosure. The rotor assembly may include: a rotor core including: a plurality of annular lamination stacks, wherein the plurality of annular lamination stacks are radially aligned and axially offset from adjacent of the plurality of annular lamination stacks to define an axial length of the rotor core, the plurality of annular lamination stacks including: a plurality of lamination stack segments, wherein the plurality of lamination stack segments are segments of an annular shape, wherein the plurality of lamination stack segments abut with circumferentially adjacent of the plurality of lamination stack segments, wherein the plurality of lamination stack segments include: a plurality of annular segments, wherein the plurality of annular segments are laminated together to form the plurality of lamination stack segments, wherein the plurality of annular segments include: an inner diameter; an outer diameter, wherein the inner diameter and the outer diameter define the annular shape; a pair of end faces, wherein the pair of end faces are disposed at opposing circumferential ends of the plurality of annular segments; a plurality of receiving openings; and a plurality of radial joints, wherein the plurality of radial joints extend radially from the inner diameter; a plurality of permanent magnets, wherein the plurality of permanent magnets are disposed in the plurality of receiving openings; and a rotor carrier, wherein the plurality of radial joints radially affix the rotor core to the rotor carrier.

In some aspects, the plurality of radial joints do not axially interlock the rotor core and the rotor carrier.

In some aspects, the rotor carrier includes a body section and a flange section, wherein the flange section axially extends from the body section, wherein the flange section is disposed radially outwards of the body section, wherein the rotor core is disposed radially outwards of and axially aligned with the body section, wherein the plurality of radial joints radially affix the rotor core to the body section.

In some aspects, the rotor core abuts the flange section.

### BRIEF DESCRIPTION OF THE DRAWINGS

The numerous advantages of the disclosure may be better understood by those skilled in the art by reference to the accompanying figures in which:

FIG. 1A depicts an outer perspective view of an annular segment, in accordance with one or more embodiments of the present disclosure.

FIG. 1B depicts a front view of the annular segment, in accordance with one or more embodiments of the present disclosure.

FIG. 1C depicts an inner perspective view of the annular segment, in accordance with one or more embodiments of the present disclosure.

FIG. 2A depicts an outer perspective view of a lamination stack segment with lines between the annular segments depicted, in accordance with one or more embodiments of the present disclosure.

FIG. 2B depicts the outer perspective view of the lamination stack segment with lines between the annular segments hidden, in accordance with one or more embodiments of the present disclosure.

FIG. 2C depicts a front view of the lamination stack segment, in accordance with one or more embodiments of the present disclosure.

FIG. 2D depicts an inner perspective view of the lamination stack segment with lines between the annular segments depicted, in accordance with one or more embodiments of the present disclosure.

FIG. 2E depicts the inner perspective view of the lamination stack segment with lines between the annular segments hidden, in accordance with one or more embodiments of the present disclosure.

FIG. 3A depicts a perspective view of an annular lamination stack including the lamination stack segments, in accordance with one or more embodiments of the present disclosure.

FIG. 3B depicts a front view of the annular lamination stack including the lamination stack segments, in accordance with one or more embodiments of the present disclosure.

FIG. 4A depicts a perspective view of a rotor core including the annular lamination stack, in accordance with one or more embodiments of the present disclosure.

FIG. 4B depicts a front view of the rotor core including the annular lamination stack, in accordance with one or more embodiments of the present disclosure.

FIG. 4C depicts a side view of the rotor core including the annular lamination stack, in accordance with one or more embodiments of the present disclosure.

FIG. 5A depicts a perspective view of a rotor assembly including the rotor core, in accordance with one or more embodiments of the present disclosure.

FIG. 5B depicts a cross-section view of the rotor assembly including the rotor core, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to electric motor rotor segment radial interlocking retention. The rotor may be segmented into annular segments to assist in manufacturing and provide material savings. Switching from a full circle rotor lamination to a segmented lamination may reduce a structural strength of the rotor to resist centrifugal forces and expansion during high speed or high temperature operation. The annular segments may include radial joints to provide sufficient strength to resist against the centrifugal forces.

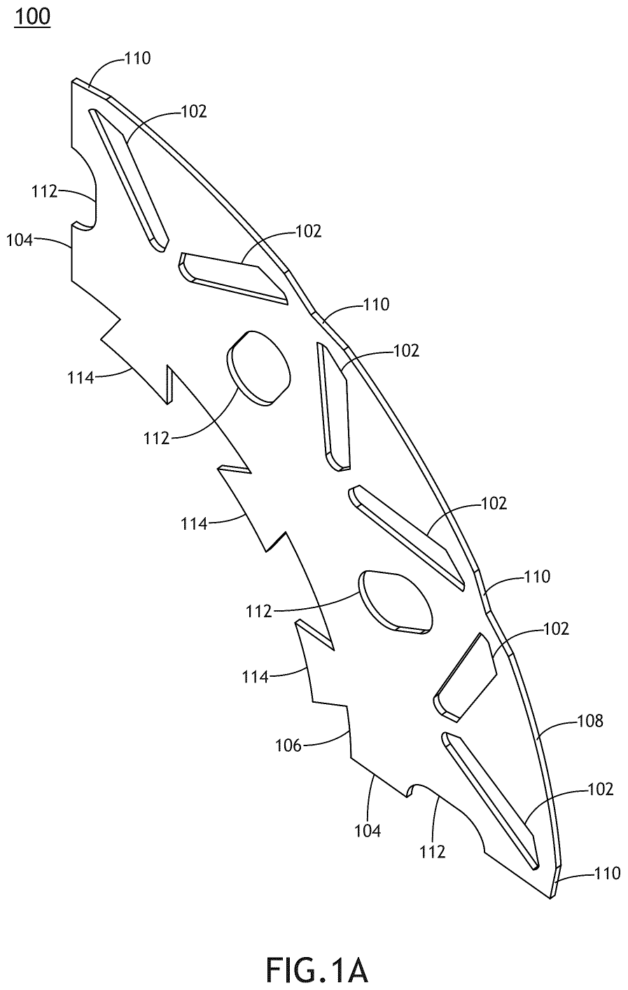

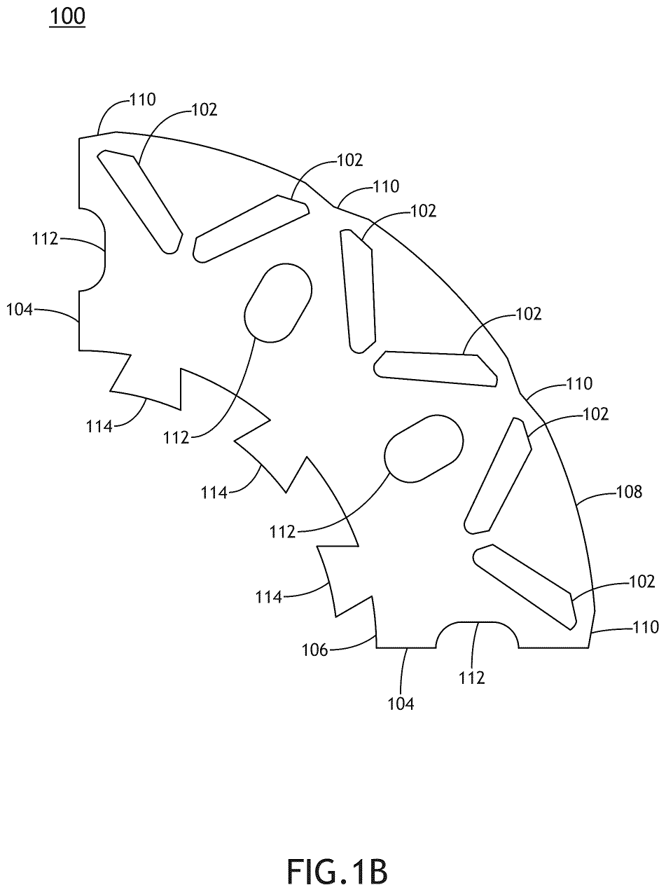

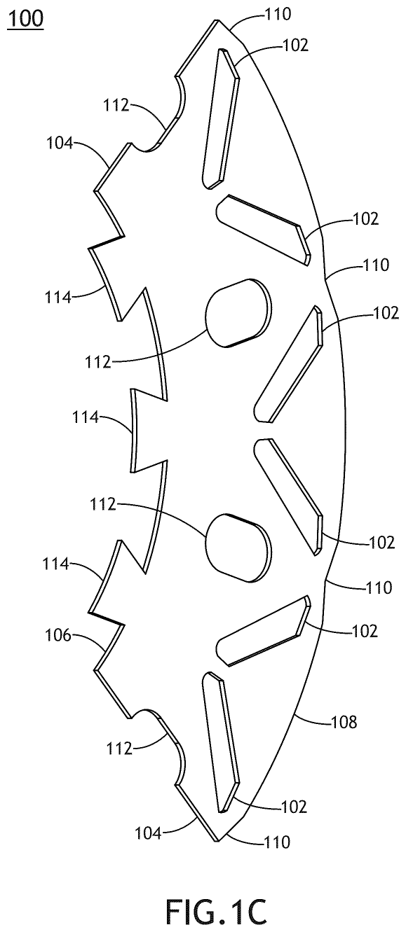

FIGS. 1A-1C depict an annular segment 100, in accordance with one or more embodiments of the present disclosure. The annular segment 100 may include receiving openings 102, end faces 104, inner diameter 106, outer diameter 108, axial grooves 110, holes 112, and/or radial joints 114.

The receiving openings 102 may be defined axially through the annular segment 100. The receiving openings 102 may be arranged in pairs to form V-shapes.

The annular segment 100 may include any number of the receiving openings 102. The annular segment 100 may include at least one pair of the receiving openings 102. For example, the annular segment 100 is depicted with three pairs of the receiving openings 102, although this is not intended as a limitation of the present disclosure.

The end faces 104 may be disposed at opposing circumferential ends of the annular segment 100. The annular segment 100 may include a pair of the end faces 104.

The annular segment 100 may be segmented such that the end faces 104 may or may not segment between the pairs of the receiving openings 102. As depicted, the end faces 104 do not segment between the pairs of the receiving openings 102, although this is not intended as a limitation of the present disclosure.

The end faces 104 may be separated from each other by an angle relative to the center axis of the annular segment 100. The angle separating the end faces 104 may be up to 180 degrees. As depicted, the angle separating the end faces 104 is 90 degrees, although this is not intended to be limiting. It is further contemplated that the angle separating the end faces 104 may be smaller than 90 degrees.

The inner diameter 106 and outer diameter 108 may be concentric. The inner diameter 106 and outer diameter 108 may be concentric to a center axis of the annular segment 100. The inner diameter 106 may be smaller than the outer diameter 108. The annular segment 100 may include an inner arc length and an outer arc length along the inner diameter 106 and the outer diameter 108, respectively. The inner arc length and the outer arc length may join the end faces 104. The inner arc length may be shorter than the outer arc length. The inner arc length and the outer arc length may be based on the inner diameter 106, the outer diameter 108, and/or the angle between the end faces 104.

The axial grooves 110 may be defined on the outer diameter 108 through the axial length of the annular segment 100. The axial grooves 110 may extend axially through the annular segment 100. The axial grooves 110 may extend along a line segment which is parallel to the center axis of the annular segment 100. The axial grooves 110 may be a V-groove, a U-groove, a rectangular-groove, or a partial groove thereof. The rectangular-groove may be an open-topped rectangular-groove. As depicted, the axial grooves 110 are V-grooves and partial grooves of the V-groove, although this is not intended to be limiting.

The axial grooves 110 may be defined at any circumferential position along the outer diameter 108. For example, the axial grooves 110 may be defined at the end faces 104 or circumferential positions therebetween. The axial grooves 110 may also be defined circumferentially between the receiving openings 102.

The annular segment 100 may define any number of the axial grooves 110. The annular segment 100 may define at least one of the axial grooves 110. As depicted, the annular segment 100 defines four of the axial grooves 110. For example, the annular segment 100 is depicted with one of the partial grooves at each of the end faces 104 and two of the axial grooves 110 at equidistant circumferential positions between the end faces 104, although this is not intended as a limitation of the present disclosure. It is further contemplated that the annular segment 100 may include more than four of the axial grooves 110.

The holes 112 may be defined axially through the annular segment 100. The holes 112 may reduce a weight of the annular segment 100. The holes 112 may be disposed at one or more circumferential positions on the annular segment 100. For example, the holes 112 may be disposed between adjacent of the receiving openings 102. The holes 112 may be disposed radially inwards of the receiving openings 102. The end faces 104 may define a portion of the holes 112. For example, halves of the holes 112 may be defined by the end faces 104.

The radial joints 114 may extend radially from the inner diameter 106. For example, the radial joints 114 may extend radially inwards and/or outwards from the inner diameter 106. The radial joints 114 may be male radial joints and female radial joints where the radial joints 114 extend radially inwards and radially outwards, respectively, from the inner diameter 106. The radial joints 114 are depicted as male radial joints, although this is not intended as a limitation of the present disclosure.

The radial joints 114 may include any type of joint. For example, the radial joints 114 may be dovetail joints, jigsaw joints, T-joints, or the like. The dovetail joints, jigsaw joints, and the T-joints may be trapezoidal, rounded, or T-shaped, respectively. As depicted, the radial joints 114 are dovetail joints.

The radial joints 114 may be disposed at any circumferential position along the inner diameter 106. As depicted, the radial joints 114 are circumferentially aligned with the pairs of the receiving openings 102, although this is not intended as a limitation of the present disclosure.

The annular segment 100 may include any number of the radial joints 114. The annular segment 100 may define at least one of the radial joints 114. As depicted, the annular segment 100 defines three of the radial joints 114.

The annular segment 100 may be a ferromagnetic metal. The ferromagnetic metal may be a metal or metal alloy thereof. The ferromagnetic metal may be ferrous or non-ferrous. For example, the ferromagnetic metal may include, but is not limited to, carbon steel, or an alloy thereof.

The annular segment 100 may be fabricated from a sheet metal blank via a stamping process. For example, multiple of the annular segments 100 may be stamped in a linear array from the sheet metal blank. The linear array may include the outer diameter 108 of the annular segments 100 disposed adjacent to the inner diameter 106 of the adjacent annular segments.

The annular segment 100 may reduce waste during the stamping process, as compared to stamping a non-segmented annulus. The inner diameter of the non-segmented annulus may be scrap material. The annular segment 100 may include a larger packing factor than the non-segmented annulus. It is further contemplated that additional material saving may be provided by decreasing the spacing between adjacent of the annular segments 100 during stamping. The spacing between adjacent of the annular segments 100 during stamping may be decreased by decreasing the arc length of the annular segments 100.

The receiving openings 102, axial grooves 110, holes 112, and/or radial joints 114 may or may not be arranged in a polar array around the center axis of the annular segment 100. The receiving openings 102, axial grooves 110, holes 112, and/or radial joints 114 may be separated from adjacent of the receiving openings 102, axial grooves 110, holes 112, and/or radial joints 114 by a same distance when arranged in the polar array. As depicted, the receiving openings 102, axial grooves 110, holes 112, and/or radial joints 114 are arranged in the polar array, although this is not intended as a limitation of the present disclosure.

The number of the receiving openings 102, axial grooves 110, holes 112, and/or radial joints 114 of the annular segment 100 may depend on the arc length of the annular segment 100. For example, the annular segment 100 may include fewer of the receiving openings 102, axial grooves 110, holes 112, and/or radial joints 114 where the arc length is shorter and more where the arc length is longer.

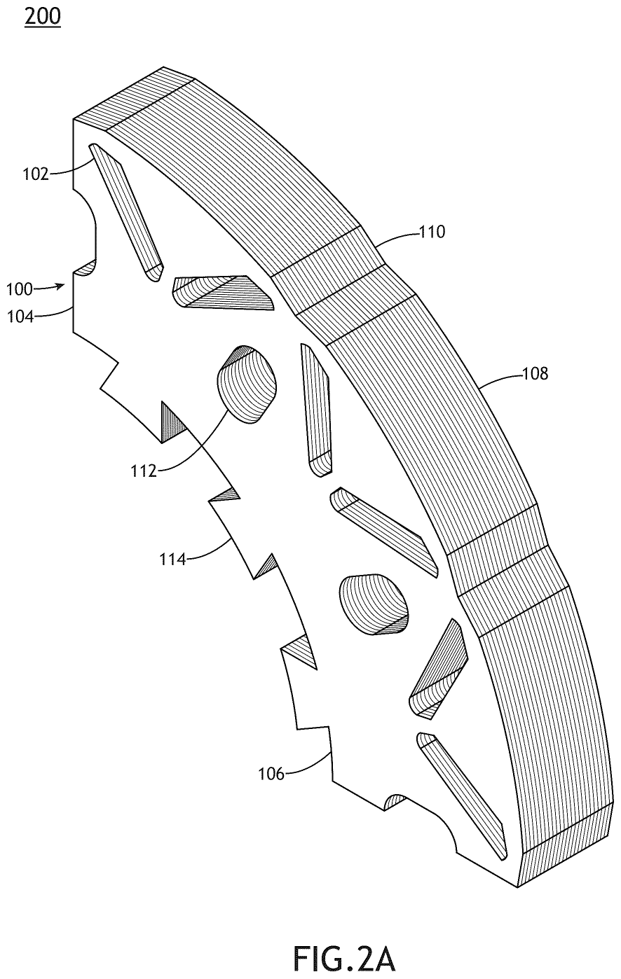

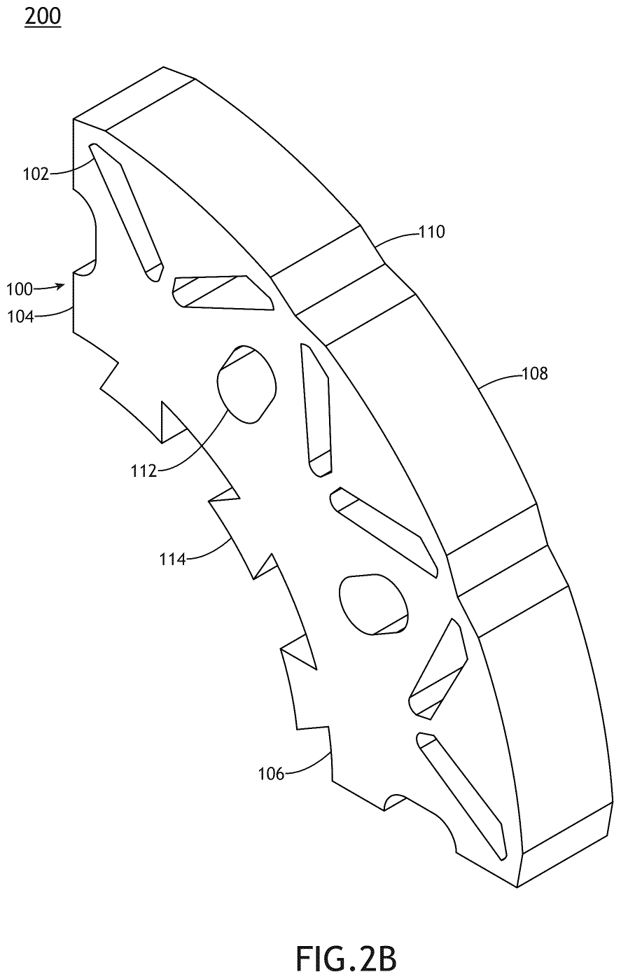

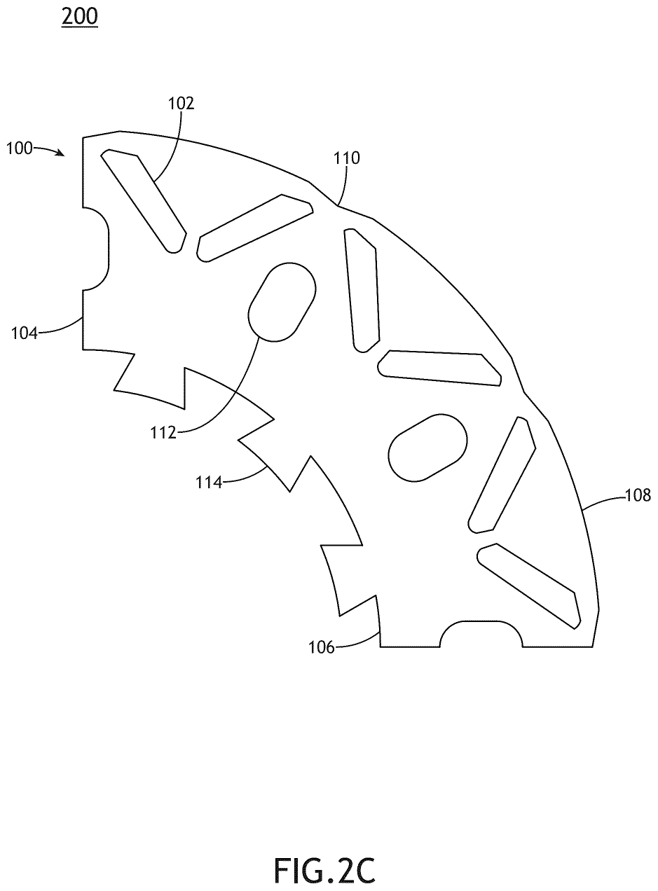

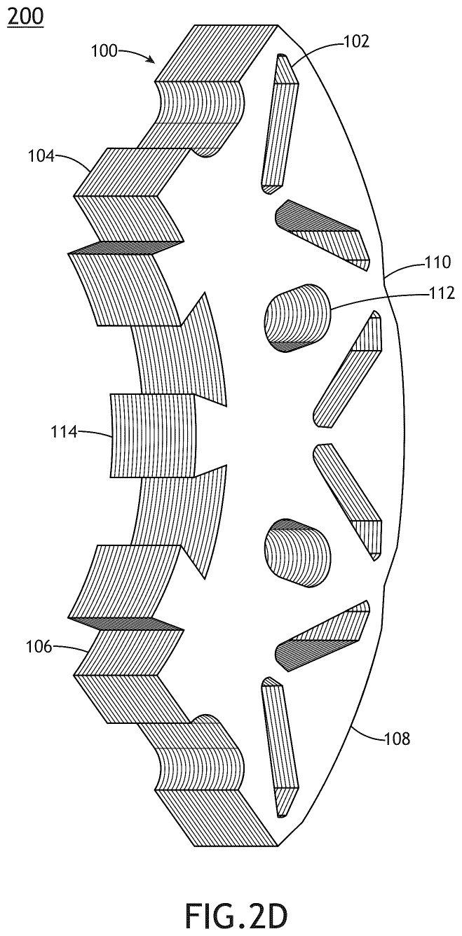

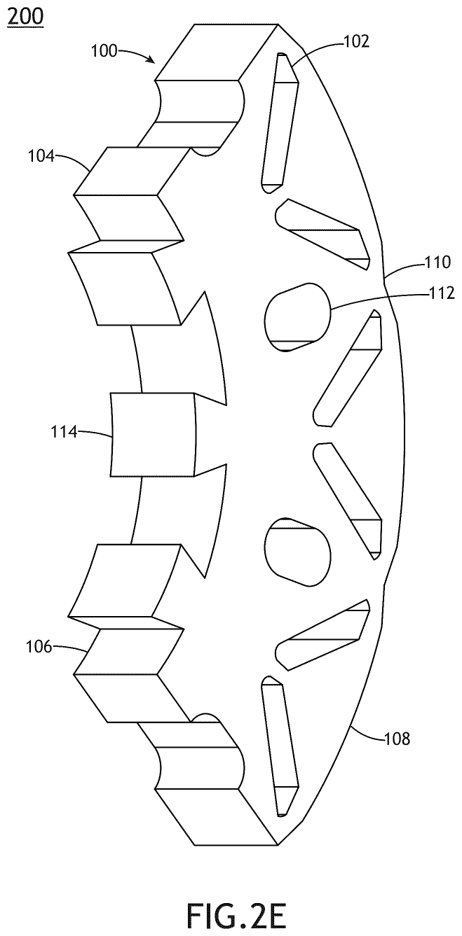

FIGS. 2A-2E depict a lamination stack segment 200, in accordance with one or more embodiments of the present disclosure. The lamination stack segment 200 may include the annular segments 100. The annular segments 100 may be laminated together to form the lamination stack segment 200. The annular segments 100 may be radially and circumferentially aligned. The annular segments 100 may be axially offset from adjacent of the annular segments 100 along the axial length of the lamination stack segment 200.

The lamination stack segment 200 may include layers of the annular segments 100. The lamination stack segment 200 may include any number of the annular segments 100. For example, the lamination stack segment 200 may include tens or hundreds of the annular segments 100. An axial length of the lamination stack segment 200 may be based on the axial length of the annular segments 100 and the number of the annular segments 100.

A profile of the lamination stack segment 200 may not change along the axial length of the lamination stack segment 200. The annular segments 100 of the lamination stack segment 200 may be identical. The receiving openings 102, end faces 104, inner diameter 106, outer diameter 108, axial grooves 110, holes 112, and/or radial joints 114 may be radially and circumferentially aligned across the annular segments 100 of the lamination stack segment 200. The annular segments 100 which are laminated together to form the lamination stack segment 200 may each include a same geometry. For example, the position and size of the receiving openings 102, end faces 104, inner diameter 106, outer diameter 108, axial grooves 110, holes 112, and/or radial joints 114 may be the same for each of the annular segments 100 which are laminated together to form the lamination stack segment 200.

The annular segments 100 may be laminated together using a fabrication process, such as, but not limited to, welding, sintering, clinching, adhering, or the like.

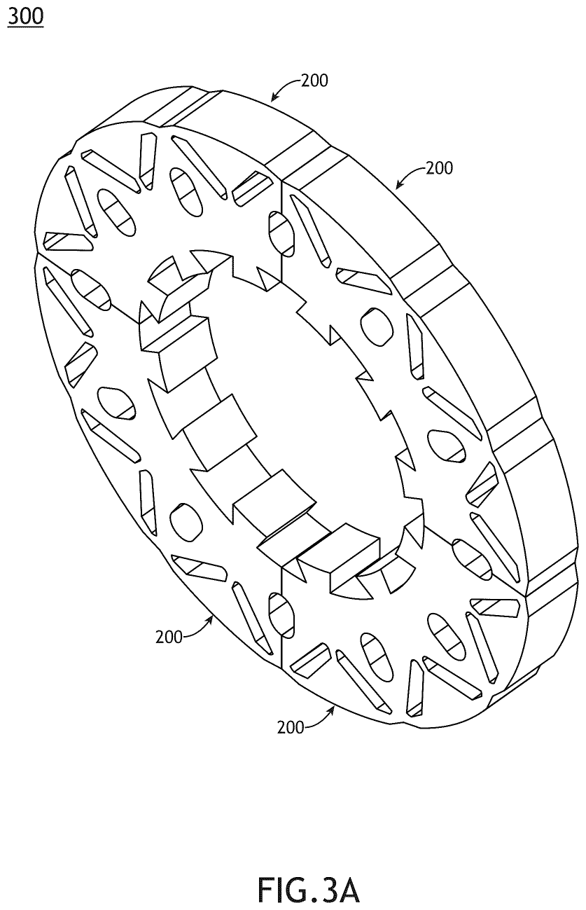

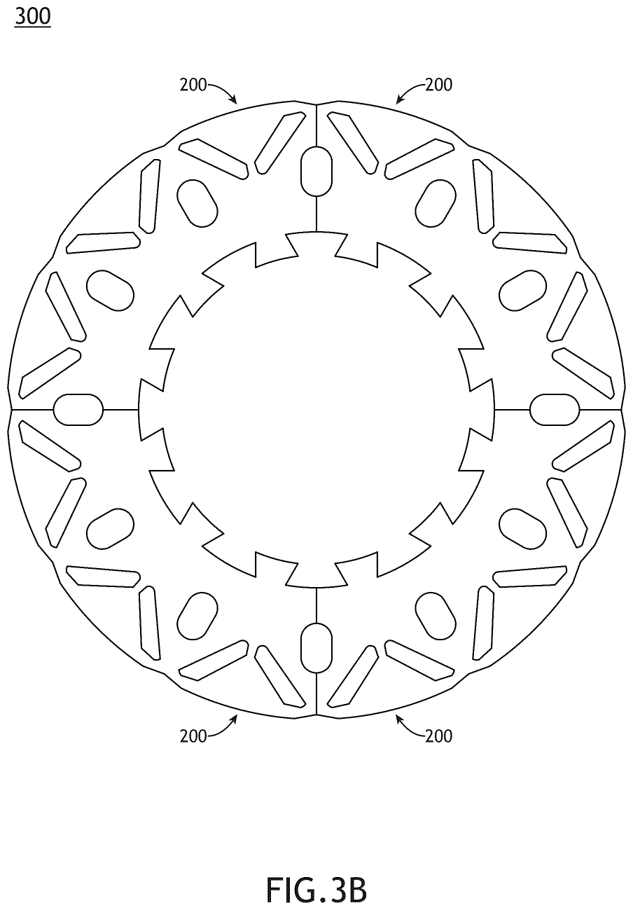

FIGS. 3A-3B depict an annular lamination stack 300, in accordance with one or more embodiments of the present disclosure. The annular lamination stack 300 may include the lamination stack segments 200. The layers of the annular segments 100 in the lamination stack segments 200 which make of the annular lamination stack 300 are not depicted for clarity.

The annular lamination stack 300 may be an annulus shape with an inner diameter and an outer diameter. The lamination stack segments 200 may be segments of the annulus shape of the annular lamination stack 300. The inner diameter 106 and the outer diameter 108 of the annular segment 100 may define the annulus shape. For example, the inner diameter 106 and the outer diameter 108 of the annular segments 100 may define the inner diameter and outer diameter, respectively, of the annulus shape. The inner diameter 106 of each of the annular segments 100 may be the same to maintain the consistent inner diameter of the annular lamination stack 300. Similarly, the outer diameter 108 of each of the annular segments 100 may be the same to maintain the consistent outer diameter of the annular lamination stack 300.

The annular lamination stack 300 may include any number of the lamination stack segments 200. For example, the annular lamination stack 300 may include at least two of the lamination stack segments 200. As depicted the annular lamination stack 300 includes four of the lamination stack segments 200, although this is not intended to be limiting. It is further contemplated that the annular lamination stack 300 may include more than four of the lamination stack segments 200 to form the annular lamination stack 300.

The lamination stack segments 200 may abut with circumferentially adjacent of the lamination stack segments 200. For example, the end faces 104 of the annular segments 100 may abut with circumferentially adjacent of the end faces 104.

The lamination stack segments 200 may not be joined with adjacent of the lamination stack segments 200. For example, the annular lamination stack 300 may not include connecting elements which connect the lamination stack segments 200 on the end faces 104. The lamination stack segments 200 may be configured to radially and/or axially translate relative to adjacent of the lamination stack segments 200 by not being joined with the adjacent of the lamination stack segments 200. The abutment between the lamination stack segments 200 may prevent the lamination stack segments 200 from translating radially inwards relative to each other but may not prevent translating radially outwards or translating axially.

The lamination stack segments 200 may or may not be include the same arc lengths. Similarly, the angles between the end faces 104 may or may not be the same between the lamination stack segments 200. However, the outer arc lengths may sum to the outer circumference of the annular lamination stack 300 and the angles between the end faces 104 may sum to 360 degrees to define the annular lamination stack 300. As depicted, the angles between the end faces 104 of each of the lamination stack segments 200 is 90 degrees, although this is not intended as a limitation of the present disclosure. In an example with four of the lamination stack segments 200, two of the lamination stack segments 200 may include the angle of 60 degrees with the other two of the lamination stack segments 200 including the angle of 90 degrees while forming the annular lamination stack 300.

The annular lamination stack 300 may include a select number of poles. The number of poles of the annular lamination stack 300 may be based on the number of the lamination stack segments 200 and the number of receiving openings 102 for each of the lamination stack segments 200. Each pole may be defined by two pairs of the receiving openings. The annular lamination stack 300 may include 6 poles, 8 poles, or more. As depicted, the annular lamination stack 300 includes 6 poles.

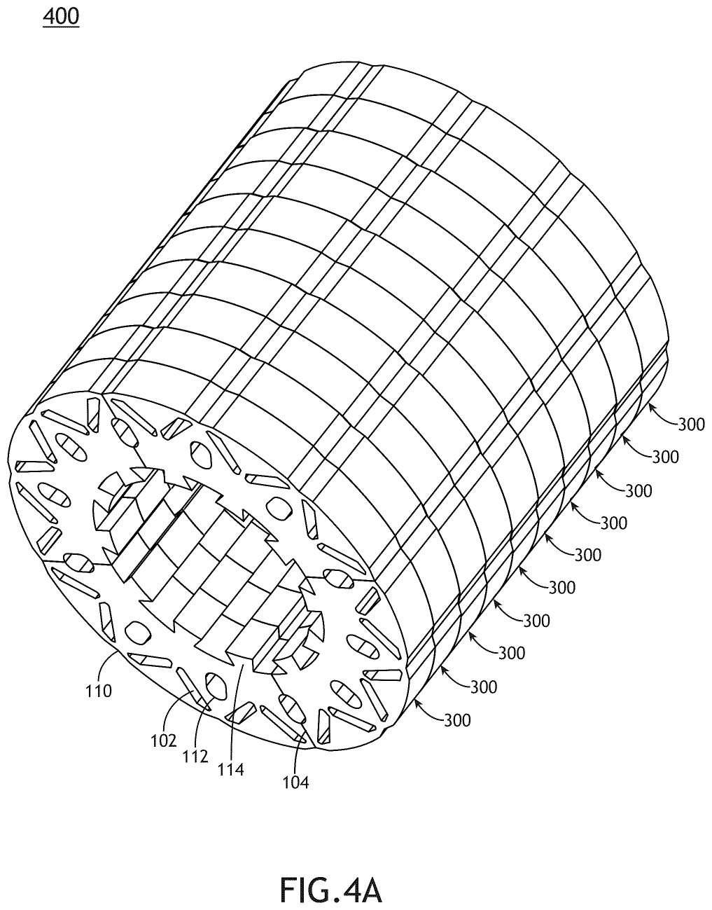

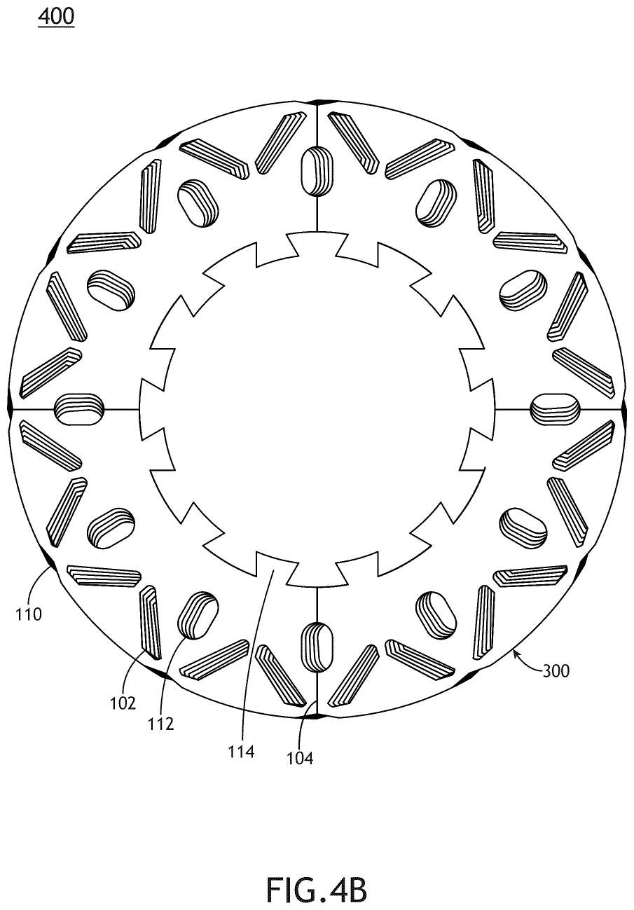

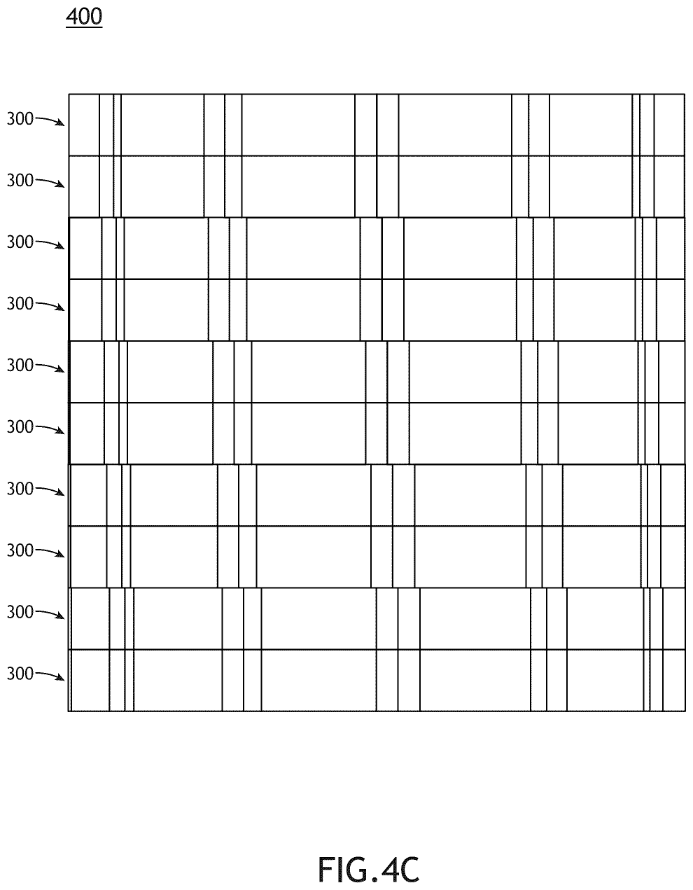

FIGS. 4A-4C depict a rotor core 400, in accordance with one or more embodiments of the present disclosure. The rotor core 400 may include the annular lamination stacks 300. The annular lamination stacks 300 may be axially stacked together to define the rotor core 400. The annular lamination stacks 300 may be radially aligned and axially offset from adjacent of the annular lamination stacks 300 to form the rotor core 400. The center axes of the annular lamination stacks 300 may be coincident.

The annular lamination stacks 300 may abut with adjacent of the annular lamination stacks 300. For example, the first layer of the annular segments 100 of the annular lamination stacks 300 may abut with the last layer of the annular segments 100 of adjacent of the annular lamination stacks 300.

The rotor core 400 may include any number of the annular lamination stacks 300. The rotor core 400 may include at least one of the annular lamination stacks 300. For example, the rotor core 400 is depicted as including ten of the annular lamination stacks 300, although this is not intended as a limitation of the present disclosure. It is further contemplated that the rotor core 400 may include more than ten of the annular lamination stacks 300.

The axial length of the rotor core 400 may be based on the number of the annular lamination stacks 300 and the axial length of the annular lamination stacks 300, where the axial length of the annular lamination stacks 300 is based on the number of the annular segments 100 per lamination stack segment 200 and the axial length of the annular segments 100.

The receiving openings 102, end faces 104, inner diameter 106, outer diameter 108, axial grooves 110, holes 112, and/or radial joints 114 may be radially aligned along the axial length of the rotor core 400. For example, the receiving openings 102, end faces 104, inner diameter 106, outer diameter 108, axial grooves 110, holes 112, and/or radial joints 114 may be radially aligned with respective of the receiving openings 102, end faces 104, inner diameter 106, outer diameter 108, axial grooves 110, holes 112, and/or radial joints 114 along the axial length. The receiving openings 102, end faces 104, inner diameter 106, outer diameter 108, axial grooves 110, holes 112, and/or radial joints 114 may be radially aligned even with a circumferential skew of the rotor core 400.

The annular lamination stacks 300 may or may not be circumferentially aligned along the axial length of the rotor core 400. The annular lamination stacks 300 may be circumferentially skewed by a skew angle. The circumferential skew of the annular lamination stacks 300 along the axial length may be beneficial to change the position of the poles along the axial length (e.g., for reducing torque ripple). As depicted, pairs of the annular lamination stacks 300 are circumferentially skewed from adjacent of the pairs by a skew angle of around 1 degree for a total skew angle of around 5 degrees along the axial length of the rotor core 400, although this is not intended to be limiting.

The receiving openings 102, end faces 104, axial grooves 110, and/or holes 112 may be circumferentially skewed along the axial length of the rotor core 400. The circumferential skew between the annular lamination stacks 300 may cause the receiving openings 102, end faces 104, axial grooves 110, and/or holes 112 to be circumferentially skewed along the axial length of the rotor core 400. For example, the receiving openings 102, end faces 104, axial grooves 110, and/or holes 112 may be circumferentially skewed by the skew angle.

The radial joints 114 may be circumferentially aligned along the axial length of the rotor core 400. In this regard, the radial joints 114 of the annular lamination stacks 300 may be circumferentially aligned along the entire axial length of the rotor core 400 and may not be circumferentially skewed along the axial length of the rotor core 400.

The annular lamination stacks 300 may include different profiles to provide both the circumferentially alignment of the radial joints 114 and the circumferential skew of the receiving openings 102, end faces 104, inner diameter 106, outer diameter 108, axial grooves 110, and/or holes 112.

The axial grooves 110 may be connected between adjacent of the annular lamination stacks 300. A fluid may flow along the axial length of the rotor core 400 via the axial grooves 110. The axial grooves 110 may be sufficiently wide to be connected even with the skew angle.

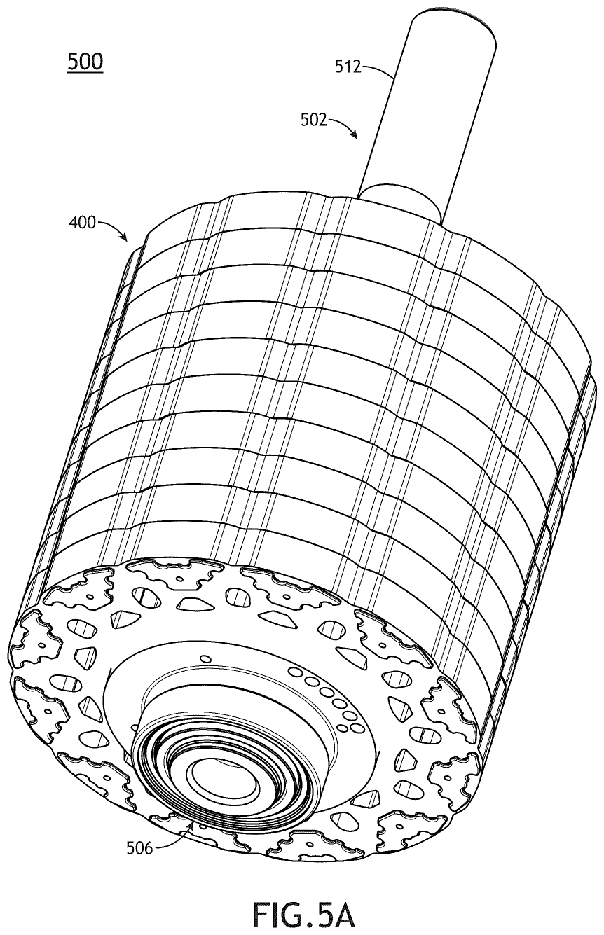

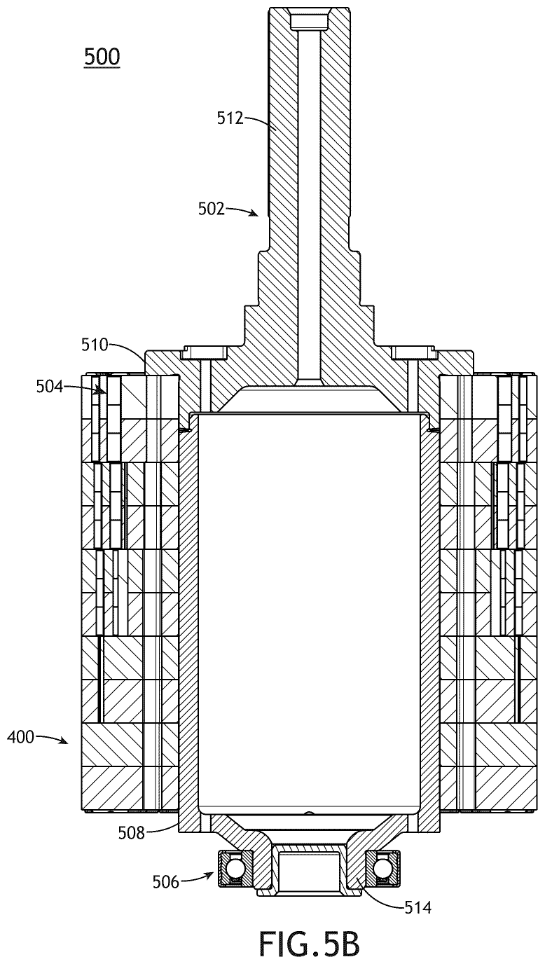

FIGS. 5A-5B depict a rotor assembly 500, in accordance with one or more embodiments of the present disclosure. The rotor assembly 500 may include the rotor core 400, a rotor carrier 502, permanent magnets 504, and/or a bearing 506.

The rotor carrier 502 may include a body section 508, a flange section 510, a spline section 512, and/or a bearing section 514. The flange section 510 and the bearing section 514 may axially extend from the body section 508. The body section 508 may be axially disposed between the flange section 510 and the bearing section 514. The bearing section 514 may be disposed radially inwards of the body section 508. The flange section 510 may be disposed radially outwards of the body section 508. The spline section 512 may axially extend from the flange section 510. The flange section 510 may be axially disposed between the body section 508 and the spline section 512. The spline section 512 may be disposed radially inwards of the body section 508 and/or the flange section 510.

The rotor core 400 may be disposed radially outwards of the rotor carrier 502. For example, the rotor core 400 may be disposed radially outwards of and axially aligned with the body section 508.

The radial joints 114 may radially affix the rotor core 400 to the rotor carrier 502. The radial joints 114 may radially affix the rotor core 400 to the body section 508 of the rotor carrier 502. The radial joints 114 may prevent the lamination stack segments 200 from translating radially outwards when the rotor assembly 500 rotates about the center axis. The radial joints 114 may provide sufficient strength between the rotor core 400 and the body section 508 to resist centrifugal forces. The circumferential alignment of the radial joints 114 may allow assembling the rotor core 400 onto the body section 508 via axial translation. For example, each of the annular lamination stacks 300 may be circumferentially pre-skewed to the skew angle and then translated axially.

The body section 508 may include opposing radial joints (not depicted) to which the radial joints 114 are coupled. The body section 508 and the rotor core 400 may include a matching number of the radial joints. The radial joints of the body section 508 may include a skew angle which matches the skew angle of the radial joints 114 along the axial length. The radial joints of the body section 508 may be blind radial joints. For example, the radial joints may not extend through the entire radial wall thickness of the body section 508. The blind radial joints may maintain the structural integrity of the body section 508.

The radial joints 114 may not axially interlock the rotor core 400 and the rotor carrier 502. The annular lamination stacks 300 may axially translate along the rotor carrier 502 during installation of the annular lamination stacks 300. For example, the radial joints 114 may be joined by a clearance fit.

The rotor core 400 may abut the flange section 510. An axial end of the rotor core 400 may abut the flange section 510. For example, a face of one of the annular lamination stacks 300 may abut the flange section 510. The abutment of the rotor core 400 and the flange section 510 may axially affix together the annular lamination stacks 300. The annular lamination stacks 300 may be clamped together via the flange section 510.

The bearing 506 may be coupled to the rotor carrier 502. For example, the bearing 506 may be coupled to the bearing section 514. The bearing 506 may support the rotor assembly 500 during rotation.

The permanent magnets 504 may be disposed within the receiving openings 102. The receiving openings 102 may receive the permanent magnets 504. The receiving openings 102 may be arranged in pairs for receiving pairs of the permanent magnets 504. The permanent magnets 504 may be oriented in the V-shape to form a pole. The permanent magnets 504 may be disposed within the receiving opening 102 in a polar array. Each of the annular lamination stacks 300 may house any number of the permanent magnets 504. The number of the permanent magnets 504 may define the number of poles of the rotor assembly 500. As depicted, the rotor assembly 500 includes twelve of the permanent magnets 504 for each of the annular lamination stacks 300 for a total of six poles, although this is not intended to be limiting.

The circumferential position of the permanent magnets 504 may be based on the circumferential skew of the annular lamination stacks 300. Varying the circumferential position may also vary the position of the poles. Thus, the circumferential position of the poles of the rotor assembly 500 may be based on the circumferential skew and may vary depending upon the axial position of the annular lamination stacks 300.

Torque may be generated by the permanent magnets 504 in response to an external magnetic field. The rotor core 400 may transmit the torque to the rotor carrier 502 via the radial joints 114. The rotor carrier 502 may then transmit the torque from the rotor assembly 500 via the spline section 512.

The rotor assembly 500 may be a rotor for an electric motor (not depicted). The electric motor may be a modular hybrid transmission (MHT), a hybrid module, an electric axle, or the like. The electric motor may include a stator (not depicted). The rotor assembly 500 may be disposed radially inwards of and axially aligned with the stator. The stator may be configured to generate the magnetic field causing the rotor assembly 500 to generate the torque.

Fluid may be provided to cool the electric motor (e.g., the rotor assembly 500 and the stator). The fluid may flow axially along the rotor assembly 500 via the axial grooves 110. In this regard, the axial grooves 110 may also be referred to as fluid grooves or fluid channels. The fluid may cool the rotor assembly 500 and the stator as the fluid travels axially along the axial grooves 110.

The term “axial” and derivatives thereof, such as “axially,” shall be understood to refer to a direction along the axis of rotation. Further, the term “radial” and derivatives thereof, such as “radially,” shall be understood in relation to the axis. For example, “radially outwards” refers to further away from the axis, while “radially inwards” refers to nearer to the axis. The term “circumferential” and derivatives thereof, such as “circumferentially,” shall be understood in a circumference at a fixed radius in relation to the axis.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 Annular segments
102 Receiving openings
104 End faces
106 Inner diameter
108 Outer diameter
110 Axial grooves
112 Holes
114 Radial joints
200 Lamination stack segments
300 Annular lamination stacks
400 Rotor core
500 Rotor assembly
502 Rotor carrier
504 Permanent magnets
506 Bearing
508 Body section
510 Flange section
512 Spline section
514 Bearing section

What is claimed:

1. An annular lamination stack comprising:
a plurality of lamination stack segments, wherein the plurality of lamination stack segments are segments of an annular shape, wherein the plurality of lamination stack segments abut with circumferentially adjacent of the plurality of lamination stack segments, wherein the plurality of lamination stack segments comprise:
a plurality of annular segments, wherein the plurality of annular segments are laminated together to form the plurality of lamination stack segments, wherein the plurality of annular segments comprise:
an inner diameter;
an outer diameter, wherein the inner diameter and the outer diameter define the annular shape;
a pair of end faces, wherein the pair of end faces are disposed at opposing circumferential ends of the plurality of annular segments;
a plurality of receiving openings; and
a plurality of radial joints, wherein the plurality of radial joints extend radially from the inner diameter.

2. The annular lamination stack of claim 1, wherein the plurality of receiving openings and the plurality of radial joints are arranged in a polar array about a center axis of the annular lamination stack, wherein the inner diameter and the outer diameter are concentric to the center axis.

3. The annular lamination stack of claim 2, wherein a profile of the plurality of lamination stack segments does not change along an axial length of the plurality of lamination stack segments.

4. The annular lamination stack of claim 1, wherein the plurality of receiving openings are defined axially through the plurality of annular segments, wherein the plurality of receiving openings are arranged in pairs to form a plurality of V-shapes.

5. The annular lamination stack of claim 4, wherein each of the plurality of annular segments comprises at least one pair of the plurality of receiving openings.

6. The annular lamination stack of claim 4, wherein the pair of end faces do not segment between the pairs of the plurality of receiving openings.

7. The annular lamination stack of claim 4, wherein the plurality of radial joints are circumferentially aligned with the pairs of the plurality of receiving openings.

8. The annular lamination stack of claim 1, wherein the plurality of annular segments comprise a plurality of axial grooves, wherein the plurality of axial grooves are defined on the outer diameter through an axial length of the plurality of annular segments.

9. The annular lamination stack of claim 1, wherein the plurality of radial joints extend radially inwards from the inner diameter.

10. The annular lamination stack of claim 1, wherein the plurality of radial joints comprise one of a dovetail joint, a jigsaw joint, or a T-joint.

11. The annular lamination stack of claim 1, wherein the plurality of annular segments comprise a ferromagnetic metal or an alloy thereof.

12. The annular lamination stack of claim 1, wherein the plurality of annular segments are fabricated from a sheet metal blank via a stamping process.

13. A rotor core comprising:
a plurality of annular lamination stacks, wherein the plurality of annular lamination stacks are radially aligned and axially offset from adjacent of the plurality of annular lamination stacks to define an axial length of the rotor core, the plurality of annular lamination stacks comprising:
a plurality of lamination stack segments, wherein the plurality of lamination stack segments are segments of an annular shape, wherein the plurality of lamination stack segments abut with circumferentially adjacent of the plurality of lamination stack segments, wherein the plurality of lamination stack segments comprise:
a plurality of annular segments, wherein the plurality of annular segments are laminated together to form the plurality of lamination stack segments, wherein the plurality of annular segments comprise:
an inner diameter;
an outer diameter, wherein the inner diameter and the outer diameter define the annular shape;
a pair of end faces, wherein the pair of end faces are disposed at opposing circumferential ends of the plurality of annular segments;
a plurality of receiving openings; and
a plurality of radial joints, wherein the plurality of radial joints extend radially from the inner diameter.

14. The rotor core of claim 13, wherein the plurality of annular lamination stacks abut with adjacent of the plurality of annular lamination stacks.

15. The rotor core of claim 13, wherein the plurality of receiving openings and the plurality of radial joints are radially aligned along the axial length of the rotor core.

16. The rotor core of claim 15, wherein the plurality of annular lamination stacks are circumferentially skewed along the axial length of the rotor core, wherein the plurality of radial joints are circumferentially aligned along the axial length of the rotor core.

17. A rotor assembly comprising:
a rotor core comprising:
a plurality of annular lamination stacks, wherein the plurality of annular lamination stacks are radially aligned and axially offset from adjacent of the plurality of annular lamination stacks to define an axial length of the rotor core, the plurality of annular lamination stacks comprising:
a plurality of lamination stack segments, wherein the plurality of lamination stack segments are segments of an annular shape, wherein the plurality of lamination stack segments abut with circumferentially adjacent of the plurality of lamination stack segments, wherein the plurality of lamination stack segments comprise:
a plurality of annular segments, wherein the plurality of annular segments are laminated together to form the plurality of lamination stack segments, wherein the plurality of annular segments comprise:
an inner diameter;
an outer diameter, wherein the inner diameter and the outer diameter define the annular shape;
a pair of end faces, wherein the pair of end faces are disposed at opposing circumferential ends of the plurality of annular segments;
a plurality of receiving openings; and
a plurality of radial joints, wherein the plurality of radial joints extend radially from the inner diameter;
a plurality of permanent magnets, wherein the plurality of permanent magnets are disposed in the plurality of receiving openings; and
a rotor carrier, wherein the plurality of radial joints radially affix the rotor core to the rotor carrier.

18. The rotor assembly of claim 17, wherein the plurality of radial joints do not axially interlock the rotor core and the rotor carrier.

19. The rotor assembly of claim 17, wherein the rotor carrier comprises a body section and a flange section, wherein the flange section axially extends from the body section, wherein the flange section is disposed radially outwards of the body section, wherein the rotor core is disposed radially outwards of and axially aligned with the body section, wherein the plurality of radial joints radially affix the rotor core to the body section.

20. The rotor assembly of claim 19, wherein the rotor core abuts the flange section.
